(19) United States
(12) Patent Application Publication
(10) Pub. No.: US 2021/0219501 A1
(43) Pub. Date: Jul. 22, 2021

(54) GREENHOUSE IMPROVEMENTS

(71) Applicant: Apex Greenhouses (Australia) Pty Ltd., South Australia (AU)

(72) Inventor: Folco Faber, South Australia (AU)

(73) Assignee: Apex Greenhouses (Australia) Pty Ltd., South Australia (AU)

(21) Appl. No.: 17/259,896

(22) PCT Filed: Jul. 12, 2019
(86) PCT No.: PCT/AU2019/050736

§ 371 Date: Jan. 12, 2021

(30) Foreign Application Priority Data
Jul. 13, 2018 (AU) 2018902540

(51) Int. Cl. A01G 9/24; E04B 9/02; E04B 7/02; E04B 1/343; E04B 9/30; E04D 13/064; A01G 9/14

(52) U.S. Cl. CPC A01G 9/24; E04B 9/02; E04B 7/022; E04B 1/343; E04B 2007/066; E04D 13/064; A01G 9/1438; A01G 9/14; E04B 9/303

(57) ABSTRACT

An improved greenhouse structure having sides and a roof to define at least a partially enclosed space, with an interior ceiling section and the interior ceiling section being at least substantially transparent. An air channel is formed between the roof and the interior ceiling section with an air input device in fluid communication with the air channel and the interior ceiling section has one or more openings through it to allow air in the air channel to pass through and into the enclosed growing space to provide a top-down air conditioned effect.

### FIELD OF THE INVENTION

The present invention relates to greenhouses and animal housing structures and in particular to greenhouses having airflow mechanisms or means to at least partially control the climate within.

### BACKGROUND

Greenhouses are used to grow plants in a preferred optimal environment and hope to provide protection from undesirable weather elements as well as helping to provide consistent growing conditions. A typical greenhouse has a main structure with a transparent roof and sides so as to allow light from the sun to pass through to warm the interior growing section of the greenhouse as well as to allow the plants to undergo photosynthesis. The main growing space of a greenhouse is relatively ventilated in order to maintain a consistent environment, which if left unchecked, can result in an undesirable buildup of heat and humidity within.

In traditional greenhouses excess humidity within the growing area may lead to an increase in plant diseases and therefore it is desirable to remove excess water vapour. Excess heat in the growing section may also have a damaging effect on the growth of the plants. In a traditional style greenhouse, typically, warm air is removed from the greenhouse by selectively opening vents in the roof and allowing the warm air to escape. Cooler, dense air is then forced into the lower section of the growing area, typically at or below the height of the growing plants; however, as the humid warm air escapes from the open vent then the overall temperature of the greenhouse growing section can drop to below the desired level and it is then required to add additional heat into the incoming air into the greenhouse so as to return the internal temperature of the greenhouse to a suitable level.

Semi-closed greenhouse used forced cooling through ducting tubes below grow gutters, which has gained some widespread use in hot arid climates. In addition to the introduction of positive pressure into the growing space to push the hot/humid air out through the upper vents, the slight positive pressure also acts as a physical barrier to the growing chamber for insects as they find it difficult to enter via the open vents when the flow of the air is urging them out or away from the greenhouse. Typically, such a process in a semi-closed greenhouse involves having a number of perforations in the ducts positioned next to or below the grow gutters, each of the perforated ducts travel along the full length of the greenhouse and have a fan located at one end to draw conditioned air in and force it out through the perforations.

### Object of the Invention

It is an object of the present invention to overcome, or at least substantially ameliorate, at least some of the disadvantages and shortcomings of the prior art.

Other objects and advantages of the present invention will become apparent from the following description, taken in connection with the accompanying drawings, wherein, by way of illustration and example, an embodiment of the present invention is disclosed.

### SUMMARY OF THE INVENTION

According to the present invention, although this should not be seen as limiting the invention in any way, there is provided a structure having sides and a roof to define at least a partially enclosed space, an interior ceiling section;
the interior ceiling section being at least substantially transparent;
an air channel formed between the roof and the interior ceiling section;
an air input device in fluid communication with the air channel; and
the interior ceiling section having one or more openings through it to allow air in the air channel to pass through and into the enclosed growing space.

In preference the structure is a greenhouse for growing plants, and the at least partially enclosed space is an enclosed growing space.

In preference, the roof has an exterior section and an interior section.

In preference, the roof is at least substantially transparent [light permeable].

In preference, both the exterior section and interior section are at least substantially transparent.

In preference, the air input means is a fan.

In preference, the air input means is a blowing device or blowing means.

In preference, the interior ceiling section is a flexible membrane.

In preference, the flexible membrane is made from ETFE (ethylene tetrafluoroethylene) or PE (polyethylene) or PVC (polyvinyl chloride) or HDPE (high-density polyethylene).

In preference, the flexible membrane is removably attached to a pair of opposing side frame members of the greenhouse.

In preference, the opposing side frame members are ceiling beams, joists or roof gutters.

In preference, the flexible membrane is removable.

In preference, the exterior section and interior section of the roof are made from transparent or translucent material to allow light to pass therethrough.

In preference, the greenhouse includes height extendable support legs.

In preference, the plurality of openings through the interior ceiling section are perforations.

In preference, the perforations increase in size along a length of the interior ceiling section.

In preference, the outer section of the roof is made from a substantially rigid material.

In preference, the air input means is fluidly connected to the air channel by a conduit.

In preference, the conduit is rigid.

In preference, the conduit is flexible.

In preference, there is an insulating pocket between the exterior section and an interior section of the roof.

In preference the structure is an animal housing or aquaculture facility.

### BRIEF DESCRIPTION OF THE DRAWINGS

By way of example, an embodiment of the invention is described more fully with reference to the accompanying drawings in which:

FIG. 1 is a 1st view of the present invention;

FIG. 2 is a side sectional view of the greenhouse as shown in FIG. 1;

FIG. 3 shows a close up of section L from FIG. 1;

FIG. 4 is a further close up of section L from FIG. 1 with glass panels in place.

### DESCRIPTION OF THE INVENTION

The present invention generally relates to an improved greenhouse and greenhouse climate control arrangement in which there is an air distribution system that draws in air and forces it into an air channel positioned in an upper section of the greenhouse, the air is then allowed to pass through apertures in the ceiling of the greenhouse and pass down and onto the crops/plants below.

Embodiments of the invention are described herein with reference to different views and illustrations that are schematic illustrations of embodiments of the invention. As such, variations from the shapes of the illustrations as a result, for example, of manufacturing techniques and/or tolerances are expected. Additionally, embodiments of the invention should not be construed as being limited to the particular shapes of the regions that are illustrated within include deviations in shapes that result, for example, from manufacturing.

It should be understood that when an element or feature is referred to as being “on” or “adjacent” another element or feature, it may be directly on or adjacent the other elements or features or intervening elements or features may also be present. Additionally, relative terms such as outer, above, lower, below and similar terms, may be used to describe the relationship of one feature to another. It is understood that these terms are intended to encompass different orientations in addition to the orientation depicted in the particular figure.

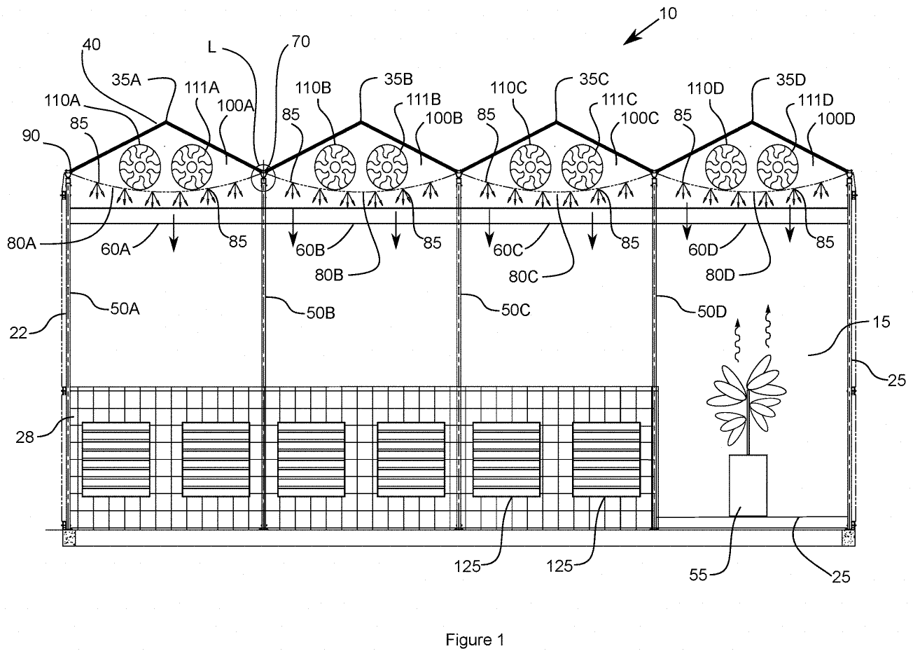

FIG. 1 shows one embodiment of a greenhouse 10 in which there is an enclosed growing space 15 defined by the walls 20 and 22, floor 25 and roof 30. In the embodiment as shown in the figures, the roof has a series of gable roofs with peaks 35. Other shapes of roofs are considered to fall within the scope of the invention.

The roof 30 (outer section) is made from a substantially transparent (light permeable) sheet material 40 and can be manufactured from glass or a suitable plastics material having the required light transmittance and physical/structural characteristics. For example, the roof 30 can be made from a polycarbonate material, preferably having physical characteristics making suitable for purpose (hail resistance, light transmittance, etc). In other instances, plastic material may be utilized using ETFE (ethylene tetrafluoroethylene) as a main covering or PVC (polyvinyl chloride) or PE (polyethylene) covering material or combination thereof. A Keder cord and rail system may be used to install and retain a roof made from a plastic material. In the alternative, a traditional system of clips or other suitable retaining means may be utilized to hold the plastic covering in place. In other embodiments, insulated or solar panels may be used as at least part of the roof section 30.

Supporting the roof 30 is a number of support legs 50A, B, C, D and 51. In one embodiment of the present invention, the support legs 50A, B, C, D and 51 are height adjustable to allow the roof section to be raised and lowered to the required height, which is typically in relation to the height of the crop to be grown in the enclosed growing space 15, but may also be varied according to desired environmental conditions as required by the grower. In the enclosed growing space 15 are a number of crop plants 55. Shutters 125 are located on the wall section 28 and allow air to enter into the growing are 15 or may allow air to enter into an adjacent passageway in communication with the fans 110, 111, whereby action of the fans draws air through the shutters 125. For ease of viewing a section of the shutters/wall has been removed to show the location of the crop plant 55.

Positioned between each of the support legs 50A, B, C, D and 51 is a support beam 60A-D, which is securely affixed to each of the adjacent support legs 50A, B, C, D and 51 so as to provide an internal brace within the greenhouse 10. The support beam 60 can be affixed or secured to the adjacent support legs 50A, B, C, D and 51 by way of conventional bolts and nuts or any other suitable fastening element that those skilled in the field would utilise.

Within the greenhouse 10 is an interior ceiling section 80 which can be made from a sheet of plastics material, which is pliable and flexible and can be a membrane material. As shown in FIG. 1, the interior ceiling 80 can be constructed from a single continuous sheet of a fixed width which spans from a first attachment 90 on the upper section of support leg 50A to second attachment 92 on the upper section of support leg 51. If required, securing attachments may be made on each of the intervening support legs 50 B, C and D although these may not be required at all installations. The pliable/flexible ceiling is allowed to sag in between each of the supporting legs, there being no requirement that the interior ceiling section 80 remain taut.

In one embodiment, the pliable/flexible interior ceiling sheet 80 may be manufactured from a plastics material suitable for use (ETFE, PE, PVC, HDPE). The plastics material has at least one opening passing through it so as to allow fluid communication from one side of the interior ceiling section 82 to the other, which leads to the enclosed growing space 15. In some embodiments, the opening may be a slit or slot of appropriate dimensions relative to the size of the span of the interior ceiling section 80 within the greenhouse 10 by having openings of desired dimension the permeability/diffusion rate of the flexible plastics sheet material can be altered in accordance with a growers need and environmental conditions so as to allow air forced into the chamber 100 to flow into the growing space at a desired rate. In other embodiments, the interior ceiling section 80 may have a plurality of openings 85 spanning the length of each sheet of material used, the openings 85 being apertures of a desired dimension, which may include apertures of varying dimensions along the length and/or width of the interior ceiling section 80. For example, in one embodiment, the apertures may gradually increase in size from one end of the sheet of the interior ceiling section 80 to another.

The installation of the interior ceiling section 80 creates an air channel 100 between the roof 30 and the interior ceiling section 80. Each of the 8 channels 100 have located at one end an air input means 110, which in this embodiment is a fan, that forces air from an external location into the air channels. As shown in FIG. 1, the embodiment provides two fans 110 and 111 for each air channel 100, however the number of fans per channel may vary according to the size of the channel and specific requirements of the greenhouse without departing from the scope of the invention. Each air input device may be separately or jointly controlled, remotely controlled and powered by a suitable motor, preferably an electric motor and allows for varying fan speeds as required.

In operation, the air input means forces air from an external location into the air channels 100 and creates a slight overpressure such that air is then forced to pass through the openings 85 and into the enclosed growing space 15. Typically the air being forced into the air channel 100 will be of a lower temperature than that of the air in the enclosed growing space and therefore will fall downwards towards the plants 55 thus cooling the greenhouse 10 from the upper section downwards. In some forms hot air may be used in some instances to control condensation in the roof to get more light to the crop with less moisture on the transparent materials. In addition, by introducing warm air into the roof cavity (air channels 100) this can insulate the building and save energy

In other embodiments, the roof section is substantially flat or a roof section having a constant slope so that the roof 30 may also be constructed from a flexible/continuous sheet of plastics material, such as for example, ETFE (ethylene tetrachloroethylene) having suitable mechanical propePCTrties/toughness. The use of a roof section made from such material then provides for a rapid installation onto the directed framework, the flexible/continuous sheet of roofing material can be fixed at a first end and tension applied across the length/width of the material and then is secured/attached to an adjacent fixing point. In addition, adjacent layers of roof material may be applied one on top of the other, with allowance for a space between the two, which may act as an insulating air pocket between the layered material. Accordingly, when in use with the interior ceiling section 80 as previously described, a number of insulating pockets can be created between the exterior of the greenhouse 10 and the enclosed growing space 15 whilst still allowing for excellent light transmittance.

In other embodiments, the air input device may be located away from or adjacent to the greenhouse and air is forced from the air input device through conduits fluidly connected to the air channels 100.

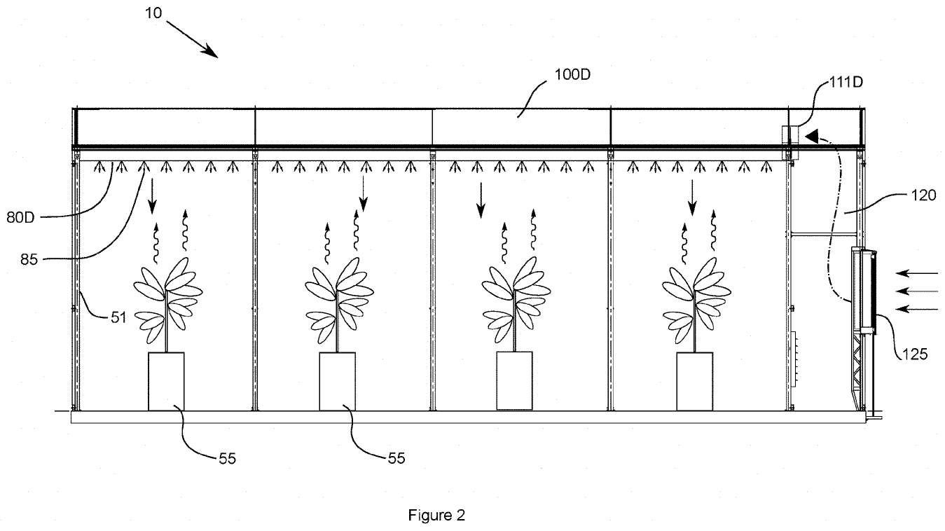

In further embodiments, the air input device 110, 111 may be located in fluid communication with a cool air chamber 120 which can be positioned adjacent to the enclosed growing space 15 of the greenhouse 10 into which conditioned air may be pumped in and then drawn into the air channels 100D by action of the input device (fans) 110 (not shown) and 111 as shown in FIG. 2. A set of shutters 125 can be operated, either manually or remotely, to control the flow of air into air chamber 120.

The diameter of the tubes in semi-closed greenhouse systems means gutters must be spaced further apart than is normal to accommodate the 900 mm diameter (typical) of the tubes. The tubes are prone to wear and tear due to movement of picking trolleys in close proximity to the tubes. It also means that for crops grown in ground inground in greenhouses (flowers etc.), for ebb and flood floor nurseries or for crops on benches or with a narrow gutter spacing (strawberries etc.) the semi-closed solution in its current form cannot be applied due to the ducting not being able to be distributed for in ground or narrowly spaced crops. These tubes cannot be suspended above the crop as this would block the light to the crop.

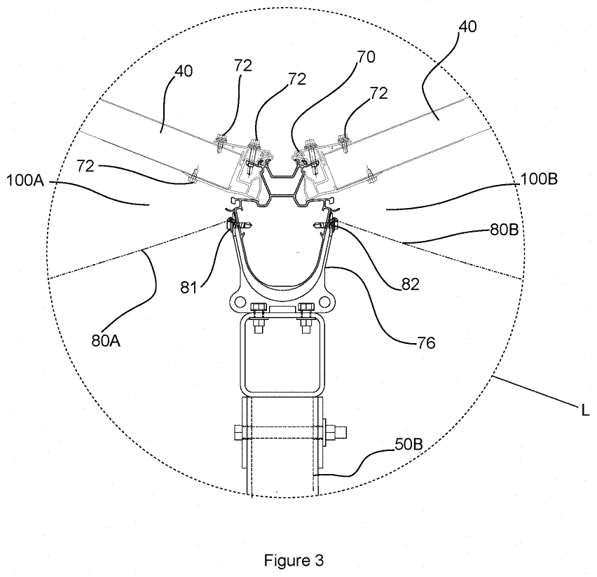

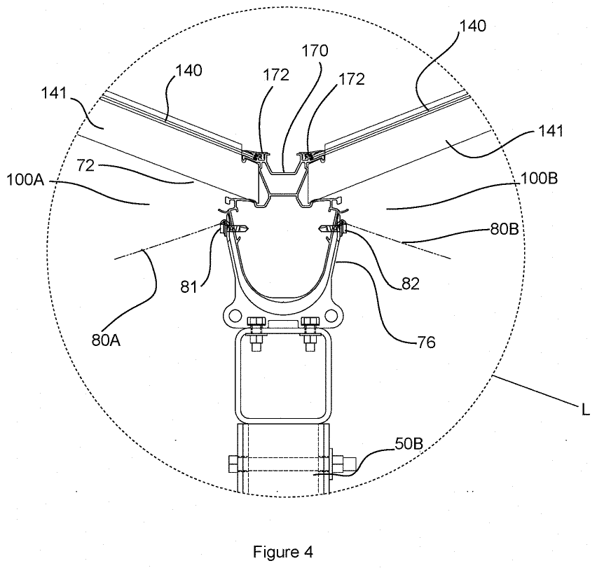

FIG. 3 shows a close up of section L from FIG. 1, in which, in this form of the invention, the roof panels 40 are made from plastic panels and are removably secured to beam 70 by way of bolts 72. In The configuration/shape of the beam 70 can be changed to suit the shape of any desired panel or sheet material used in greenhouse construction, for example glass/plastic panels that are slotted into place in a channel on the beam 70, or plastic roof sheeting/film held in place to the beam by way of a Keder system or other suitable fastening/securing system. FIG. 4 shows an example of the present invention using a glass panel system as the roof 140 and beams (or chords) 141. The glass panels 140 are slotted into the slots 172 of the beam 170. As can be appreciated, the beam shape can be easily selected depending on the type of greenhouse construction is required. The interior ceiling section 80 is then fastened to the sides of the beam 76 by way of standard clips and screw fasteners 81 and 82 respectively. Alternatively, a Keder cord system may be used to retain the flexible interior ceiling section.

In addition, warm air may be forced into the air channels 100 as a way of helping to combat the build-up of snow that occurs on greenhouse roofs in the northern hemisphere. The snow acts to block light and places undue pressure on the greenhouse structure. By introducing hot air into air channel an efficient snow melt may be achieved and with the hot air being trapped in this cavity give greater insulation from outdoor temperatures.

As can now be appreciated, the present invention allows for the construction of a greenhouse structure with top down ventilation that can be easily constructed and maintained compared to known greenhouse structures, in addition, the interior ceiling section and outer roof section can be easily changed/repaired depending on the requirements of the grower and local weather conditions. For example, the outer roof section 40 can be readily replaced with panels/roof material desired by the grower using standard fastening elements/systems. The interior ceiling section is readily installed, again using standard fastening elements/systems and the diffusion/permeability of the interior ceiling section can be altered by replacement of the interior ceiling section with a plastics material of desired permeability to suit the growers needs, which may be crop or environment dependant.

The reference in this specification to any prior publication (or information derived from it), or to any matter which is known, is not, and should not be taken as, an acknowledgement or admission or any form of suggestion that that prior publication (or information derived from it) or known matter forms part of the common general knowledge in the field of endeavour to which this specification relates.

1. A structure having sides and a roof to define at least a partially enclosed space,
an interior ceiling section being a flexible membrane;
the interior ceiling section being at least substantially transparent;
an air channel formed between the roof and the interior ceiling section;
an air input device in fluid communication with the air channel; and
the interior ceiling section having one or more openings, said one or more openings being performations, through it to allow air in the air channel to pass through and into the enclosed growing space.

2. The structure of claim 1, wherein the structure is a greenhouse for growing plants, and the at least partially enclosed space is an enclosed growing space.

3. The structure of claim 1, wherein the roof has an exterior section and an interior section.

4. The structure of claim 3, wherein the roof is at least substantially transparent [light permeable].

5. The structure of claim 3, wherein both the exterior section and interior section are at least substantially transparent.

6. The structure of claim 1, wherein the air input means is a fan.

7. The structure of claim 6, wherein the air input means is a blowing device or blowing means.

8. The structure of claim 1, wherein the flexible membrane is made from ETFE (ethylene tetrafluoroethylene) or PE (polyethylene) or PVC (polyvinyl chloride) or HDPE (high-density polyethylene).

9. The structure of claim 1, wherein the flexible membrane is removably attached to a pair of opposing side frame members of the greenhouse.

10. The structure of claim 1, wherein the opposing side frame members are ceiling beams, joists or roof gutters.

11. The structure of claim 1, wherein the flexible membrane is removable.

12. The structure of claim 1, wherein the exterior section and interior section of the roof are made from transparent or translucent material to allow light to pass therethrough.

13. The structure of claim 2, wherein the greenhouse includes height extendable support legs.

14. The structure of claim 1, wherein the perforations increase in size along a length of the interior ceiling section.

15. The structure of claim 1, wherein the outer section of the roof is made from a substantially rigid material.

16. The structure of claim 1, wherein the air input means is fluidly connected to the air channel by a conduit.

17. The structure of claim 16, wherein the conduit is rigid.

18. The structure of claim 17, wherein the conduit is flexible.

19. The structure of claim 1, wherein there is an insulating pocket between the exterior section and an interior section of the roof.

20. The structure of claim 1, wherein the structure is an animal housing or aquaculture facility.
